(19) United States
(12) Patent Application Publication
(10) Pub. No.: US 2005/0232121 A1
(43) Pub. Date: Oct. 20, 2005

(54) Refracting objective optical system and optical recording/reproducing device using the same

(76) Inventors: Kenji Konno, Sakai-shi (JP); Masahiro Okitsu, Suita-shi (JP); Kazuyuki Ogura, Yao-shi (JP); Hiroshi Hatano, Takatsuki-shi (JP)

Correspondence Address: SIDLEY AUSTIN BROWN & WOOD LLP, 717 NORTH HARWOOD, SUITE 3400, DALLAS, TX, 75201, US

(21) Appl. No.: 11/096,065

(22) Filed: Mar. 30, 2005

(30) Foreign Application Priority Data
Mar. 31, 2004 (JP) 2004-107953
Aug. 20, 2004 (JP) 2004-241630

(51) Int. Cl. G11B 7/00

(52) U.S. Cl. 369/112.23; 369/112.08

(57) ABSTRACT

A refracting objective optical system used in recording and/or reproducing information by near field light includes an aspherical lens in which an entrance surface is a continuous aspheric surface of convex shape and an exit surface is a flat surface, and a transparent flat plate joined to the flat surface of the relevant lens. The ray entering a first surface of the lens is refracted at the first surface, transmitted through a second surface and the flat plate, and condensed at a microscopic spot near an exit surface of the flat plate. The transparent flat plate includes a microscopic structure for generating a surface excitation plasmon near a light condensing point of the exit surface.

The present application claims priority to Japanese Patent Application No. 2004-241630 filed Aug. 20, 2004 and No. 2004-107953 filed Mar. 31, 2004, the entire contents of which are hereby incorporated by reference.

### BACKGROUND OF THE INVENTION

1. Field of the Invention

The present invention relates to refracting objective optical systems, more specifically to a refracting objective optical system used in condensing incident light at a microscopic spot, more specifically used in recording and/or reproducing information with the near field light, and to an optical recording/reproducing device using the same.

2. Description of the Related Art

Recently, in the optical recording/reproducing technique, various proposals in using the near field light generating structure to obtain a microscopic light spot have been made. The proposal is such to have the evanescent wave and the recording medium interact by bringing the light condensed by the optical system and the recording medium close.

To achieve recordation/reproduction with the near field light, a solid immersion lens (SIL) or a solid immersion mirror (SIM) is conventionally used to bring the microscopic spot and the recording medium close. High-density in recordation or reproduction of information is thereby achieved.

However, in condensing light only with SIL or SIM, the size of the light condensing spot has a limitation of about the wavelength or about half the wavelength at minimum, and is difficult to be made smaller. In order to go beyond such limit, a method of arranging a near field light generating structure near the light condensing spot is proposed and various types of near field light generating structures are disclosed in the Research Journal of Micro-optics “Micro-Optics”.

Further, in Japanese Laid-Open Patent Publication No. 2000-163794, the microscopic spot is realized by combining the SIL or SIM with an elongate slit serving as a near field light generating structure. Further, in Japanese Laid-Open Patent Publication No. 11-203712, a specific example of design of an element for condensing a parallel light at one lens is disclosed. For similar purpose, in Japanese Laid-Open Patent Publication No. 11-339310 and Japanese Laid-Open Patent Publication No. 2000-19315, a design arranged with Fresnel lens or diffraction lens is proposed, and in Japanese Laid-Open Patent Publication No. 2000-82231, a design formed into a gradient index lens is proposed. Further, in Japanese Laid-Open Patent Publication No. 2000-207764, a design in which light is condensed with a hologram lens and the like is proposed.

However, as disclosed in Japanese Laid-Open Patent Publication No. 2000-163794, a problem arises that an objective lens becomes necessary when condensing light using the SIL, which objective lens must synchronously operate with SIL during recordation/reproduction, and thus the control system of operations becomes complicating. Further, as the distance between the objective lens and the SIL requires adjustment at high precision of about the wavelength, the difficulty of manufacturing becomes high.

Further, a configuration including the SIM using one part of a paraboloid of revolution and the near field light generating structure of slit shape, or the catadioptric SIM is disclosed in Japanese Laid-Open Patent Publication No. 2000-163794. The SIM does not require an objective lens as with the SIL, but the lens shape becomes complicating and besides having a problem of the manufacturing becoming difficult, the precision required for the reflecting surface becomes harder than a transmission optical system, and thus the manufacturing cost increases.

As disclosed in Japanese Laid-Open Patent Publication No. 11-203712, in the near field light recording method of condensing the light at only one lens, the difficulty of manufacturing is low and the configuration is simple, but has limitations in making the diameter of the light condensing spot small.

Further, since there is only one optical surface, the aberration of the axial ray may be suppressed, but problems in that there is no degree of freedom for performing off-axis aberration correction (when the incident light is slightly tilted) thus lowering the off-axis performance and in that the light condensing spot becomes large arise.

In the Fresnel lens or diffraction lens disclosed in Japanese Laid-Open Patent Publication No. 11-339310 and Japanese Laid-Open Patent Publication No. 2000-19315, a problem arises that discontinuous points are formed at the lens, and thus the efficiency is lowered from scattering at the discontinuous point and high NA cannot be achieved due to manufacturing limitations of a pitch at the peripheral part of the lens.

In the gradient index lens disclosed in Japanese Laid-Open Patent Publication No. 2000-82231, a problem arises in light condensing performance since the control of the refractive index profile for completely correcting the wave aberration is difficult. Further, in the hologram lens disclosed in Japanese Laid-Open Patent Publication No. 2000-207764, a problem in that diffraction efficiency and chromatic aberration are low arises.

### SUMMARY OF THE INVENTION

The present invention mainly aims to provide a refracting objective optical system that has a simple configuration and thus is easy to manufacture and that forms a microscopic near field light at high light-use efficiency.

The present invention also aims to provide a refracting objective optical system that satisfactorily corrects off-axis aberration in addition to axial aberration.

The present invention further aims to provide an optical recording/reproducing device using the near field light generated at the refracting objective optical system.

In one aspect of the present invention, the refracting objective optical system includes an aspherical lens in which an entrance surface is a continuous aspheric surface of convex shape and an exit surface is a flat surface, and a transparent flat plate joined to the flat surface of the aspherical lens; where the ray entering the aspheric surface of the aspherical lens is refracted at the aspheric surface, transmitted through the flat surface or the joint surface, and condensed near the exit surface of the transparent flat plate; and the transparent flat plate includes a microscopic structure for generating a near field light smaller than a light condensing spot near the light condensing point of the exit surface, which when the thickness of the transparent flat plate is tP, satisfies the equation 0.01<tP/tL<1.0.

According to the above refracting objective optical system, it is configured from an aspherical lens and an antireflection coating integrally joined together, the objective lens becomes unnecessary, and the manufacturing is facilitated. Particularly, the aspherical lens is configured from a continuous aspherical lens and a flat surface, and thus is easily produced from the conventional glass molding method or a plastic molding method. Further, since the entrance surface is a continuous aspheric surface, the aberration is satisfactorily corrected and the light is efficiently transmitted. Moreover, since the microscopic structure for generating the near field light smaller than the light condensing spot is arranged near the light condensing point of the transparent flat plate, the microscopic light spot is obtained at high efficiency.

In addition, as the light condensing surface is a flat surface, the microscopic distance between the light condensing point and the recording medium is easily measured/controlled, and the light condensing spot is easily brought close to the recording medium. When the thickness of the aspherical lens is tL and the thickness of the transparent flat plate is tP, the equation 0.01<tP/tL<1.0 is satisfied, and thus a satisfactory optical performance is obtained while reducing the thickness of the entire optical system.

In another aspect of the present invention, the numerical aperture NA of the aspherical lens of the refracting objective optical system is preferably greater than 0.6. This is because the refraction at the continuous aspheric surface excels in light condensability at high NA.

The microscopic structure is preferably formed by a metal that generates plasmon resonance. Through the use of electric field amplification effect by the surface excitation plasmon resonance, a satisfactory light condensing efficiency is obtained. Such microscopic structure preferably has, for example, a configuration in which the distal ends of one pair of projections face each other and are brought close to each other, and a light of a polarizing direction substantially parallel to the direction the pair of distal ends face each other enters therein.

The film thickness of the adhesive interposed between the aspherical lens and the transparent flat plate is preferably less than or equal to 50λ when the wavelength of the incident light is λ. The variation of the light condensing position involved in change of film thickness of the adhesive is suppressed as small as possible.

In the refracting objective optical system according to the present invention, the aspherical lens is configured from a first lens made of a first material having a predetermined index of refraction, and a second lens made of a second material having a predetermined index of refraction, where the opposing surfaces of the first and the second lens are adhered at a substantially same shape, and the incident ray is transmitted in the order of the first lens, the second lens and the transparent flat plate and condensed near the exit surface of the transparent flat plate.

The first lens and the second lens are combined to form a single aspherical lens, and thus the aberration is more freely corrected with the two optical surfaces of the entrance surface of the first lens and the cementing surface of the second lens, and the off-axis aberration is effectively corrected in addition to the axial aberration.

Preferably, the cementing surface of the first lens and the second lens are aspheric surfaces for the purpose of correcting the off-axis aberration.

The first lens and the second lens may each be molded through the glass molding method or the injection molding method and then adhered by way of an adhesive layer, or may be a compound lens in which one of the first lens or the second lens is molded through the glass molding method or the injection molding method and the other lens is integrated thereto by molding the transparent resin on the relevant lens.

The invention itself, together with further objects and attendant advantages, will best be understood by reference to the following detailed description taken in conjunction with the accompanying drawings.

### BRIEF DESCRIPTION OF THE DRAWINGS

FIG. 1 is a configuration view showing embodiment 1 of a refracting objective optical system according to the pesent invention;

FIG. 2 is a configuration view showing embodiment 2 of a refracting objective optical system according to the pesent invention;

FIG. 3 is a configuration view showing embodiment 3 of a refracting objective optical system according to the present invention;

FIG. 4 is a configuration view showing embodiment 4 of a refracting objective optical system according to the present invention;

FIGS. 5(A)-(H) are graphs showing an aberration property of embodiment 1;

FIGS. 6(A)-(H) are graphs showing an aberration property of embodiment 2;

FIGS. 7(A)-(H) are graphs showing an aberration property of embodiment 3;

FIGS. 8(A)-(H) are graphs showing an aberration property of embodiment 4;

FIG. 9 is a plan view showing a first example of a microscopic structure formed on a light condensing surface;

FIG. 10 is a plan view showing a second example of a microscopic structure formed on a light condensing surface;

FIG. 11 is a perspective view showing a third example of a microscopic structure formed on a light condensing surface;

FIG. 12 is a configuration view showing embodiment 5 of a refracting objective optical system according to the present invention;

FIG. 13 is a configuration view showing embodiment 6 of a refracting objective optical system according to the present invention;

FIG. 14 is a configuration view showing embodiment 7 of a refracting objective optical system according to the present invention;

FIG. 15 is a configuration view showing embodiment 8 of a refracting objective optical system according to the present invention;

FIG. 16 is a configuration view showing embodiment 9 of a refracting objective optical system according to the present invention;

FIG. 17 is a graph showing an aberration property of embodiment 5;

FIG. 18 is a graph showing an aberration property of embodiment 6;

FIG. 19 is a graph showing an aberration property of embodiment 7;

FIG. 20 is a graph showing an aberration property of embodiment 8;

FIG. 21 is a graph showing an aberration property of embodiment 9;

FIG. 22 is a plan view showing a fourth example of a microscopic structure formed on a light condensing surface; and

FIG. 23 is a configuration view showing an embodiment of an optical recording/reproducing device according to the present invention.

In the following description, like parts are designated by like reference numbers throughout the several drawings.

### DETAILED DESCRIPTION OF THE PREFERRED EMBODIMENTS

A refracting objective optical system and an optical recording/reproducing device according to the present invention will now be explained based on the drawings but the present invention is not limited in any way to the following embodiments.

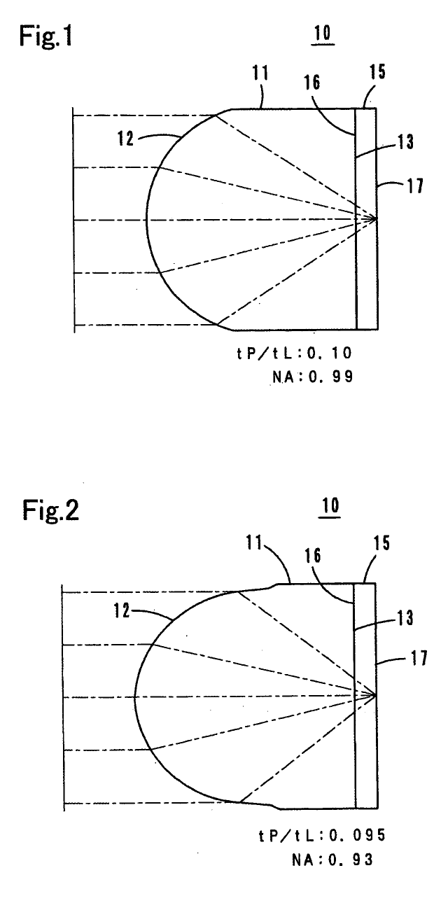

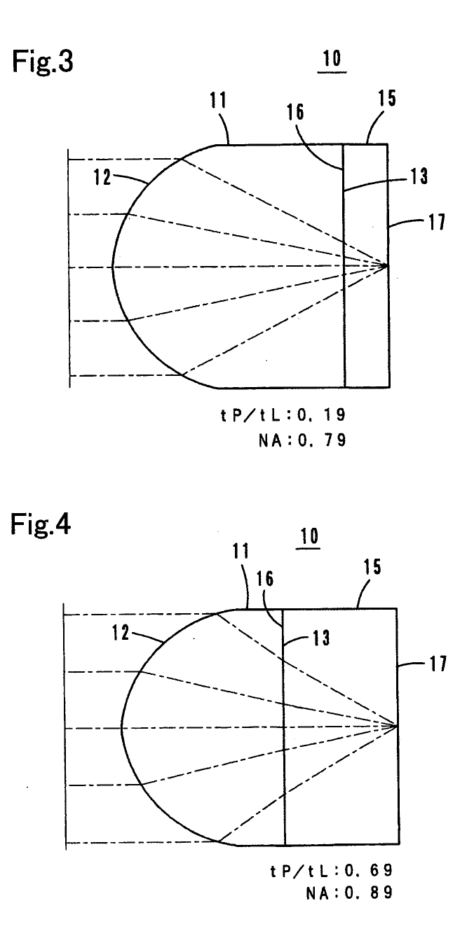

FIG. 1 to FIG. 4 show configurations and light paths (refer to a dashed line) of embodiments 1 to 4 of the refracting objective optical system according to the present invention. Further, FIGS. 5 to FIGS. 8 each shows the aberration property of embodiments 1 to 4.

In each of FIG. 1 to FIG. 4, the refracting objective optical system 10 is configured from an aspherical lens 11 and a transparent flat plate 15. The aspherical lens 11 includes a first surface 12 which is a continuous aspheric surface of convex shape and a second surface 13 which is a flat surface. The transparent flat plate 15 includes a third surface 16 and a fourth surface 17 parallel with respect to each other. The second surface 13 of the aspherical lens 11 and the third surface 16 of the flat plate 15 are joined with an adhesive.

The parallel ray first enters the first surface 12 which is an aspheric surface. Only the first surface 12 has refractive power in the refracting objective optical system 10, and thus the aspheric surface shape for condensing the light without aberration at the fourth surface 17 acting as an exit surface, to be hereinafter described, is uniquely derived. The light refracted at the first surface 12 enters the second surface 13 which is a flat surface. The second surface 13 is joined with the third surface 16 of the flat plate 15, and thus the light transmitting through the second surface 13 is condensed in the vicinity of the fourth surface 17 of the flat plate 15.

Here, the construction data relating to embodiments 1 to 4 are shown in the following tables 1 to 4. The definitional equation of the aspheric surface is expressed with the following equation (1).
X=CY²/{1+(1−(1+K)·C²·Y²)^{1/2}}+πAⁱ·Yⁱ (1)
where
X: position from a reference plane in a direction of the optical axis
Y: height in a direction perpendicular to the optical axis
C: paraxial curvature
K: conical coefficient

Aⁱ: aspheric surface coefficient of i^{th} power

TABLE 1
Example 1

| | | |
|---|---|---|
| Wavelength | 780 | mm |
| Effective Diameter | 1.5 | mm |
| Focal length in air | 0.919 | mm |
| Maximum off-axis angle | 0.3° | |
| Maximum axial angle of incidence | 30° | |

| Surface | Curvature | | | | | |
|---|---|---|---|---|---|---|
| data | radius | K | A4 | A6 | A8 | A10 |
| First | 0.72694 | −0.30514 | −2.98936E−03 | 5.39817E−03 | −1.15952E−02 | 0.00000E+00 |
| surface | | | | | | |

| | Thickness of lens | Thickness of adhesive | Thickness of flat plate |
|---|---|---|---|
| Distance data | 1.5070 | 0.0030 | 0.1500 |

| | Lens | Adhesive | Flat plate |
|---|---|---|---|
| Index of refraction data | 1.791049 | 1.511183 | 1.981051 |

TABLE 2
Example 2

| | | |
|---|---|---|
| Wavelength | 780 | mm |
| Effective Diameter | 1.5 | mm |
| Focal length in air | 1.1355 | mm |
| Maximum off-axis angle | 0.3° | |
| Maximum axial angle of incidence | 35° | |

| Surface | Curvature | | | | | |
|---|---|---|---|---|---|---|
| data | radius | K | A4 | A6 | A8 | A10 |
| First | 0.58910 | −0.43154 | −5.77227E−03 | 1.77968E−02 | −2.70382E−02 | 0.00000E+00 |
| surface | | | | | | |

| | Thickness of lens | Thickness of adhesive | Thickness of flat plate |
|---|---|---|---|
| Distance data | 1.5812 | 0.0030 | 0.1500+TZ,1/43 |

| | Lens | Adhesive | Flat plate |
|---|---|---|---|
| Index of refraction data | 1.518809 | 1.511183 | 1.613359 |

TABLE 3
Example 3

| | | |
|---|---|---|
| Wavelength | 405 | mm |
| Effective Diameter | 2.5 | mm |
| Focal length in air | 1.9199 | mm |
| Maximum off-axis angle | 0.3° | |
| Maximum axial angle of incidence | 25° | |

| Surface | Curvature | | | | | |
|---|---|---|---|---|---|---|
| data | radius | K | A4 | A6 | A8 | A10 |
| First | 1.18640 | −0.36936 | −1.21089E−03 | 6.83273E−04 | −5.74185E−04 | 0.00000E+00 |
| surface | | | | | | |

| | Thickness of lens | Thickness of adhesive | Thickness of flat plate |
|---|---|---|---|
| Distance data | 2.6627 | 0.0100 | 0.5000 |

| | Lens | Adhesive | Flat plate |
|---|---|---|---|
| Index of refraction data | 1.617948 | 1.530196 | 1.864142 |

TABLE 4
Example 4

| | | |
|---|---|---|
| Wavelength | 780 | mm |
| Effective Diameter | 2 | mm |
| Focal length in air | 1.4870 | mm |
| Maximum off-axis angle | 0.3° | |
| Maximum axial angle of incidence | 30° | |

| Surface | Curvature | | | | | |
|---|---|---|---|---|---|---|
| data | radius | K | A4 | A6 | A8 | A10 |
| First | 0.84948 | −0.38320 | −5.14390E−03 | 5.16012E−03 | −6.57455E−03 | 0.00000E+00 |
| surface | | | | | | |

| | Thickness of lens | Thickness of adhesive | Thickness of flat plate |
|---|---|---|---|
| Distance data | 1.4477 | 0.0100 | 1.0000 |

| | Lens | Adhesive | Flat plate |
|---|---|---|---|
| Index of refraction data | 1.571271 | 1.511183 | 1.785655 |

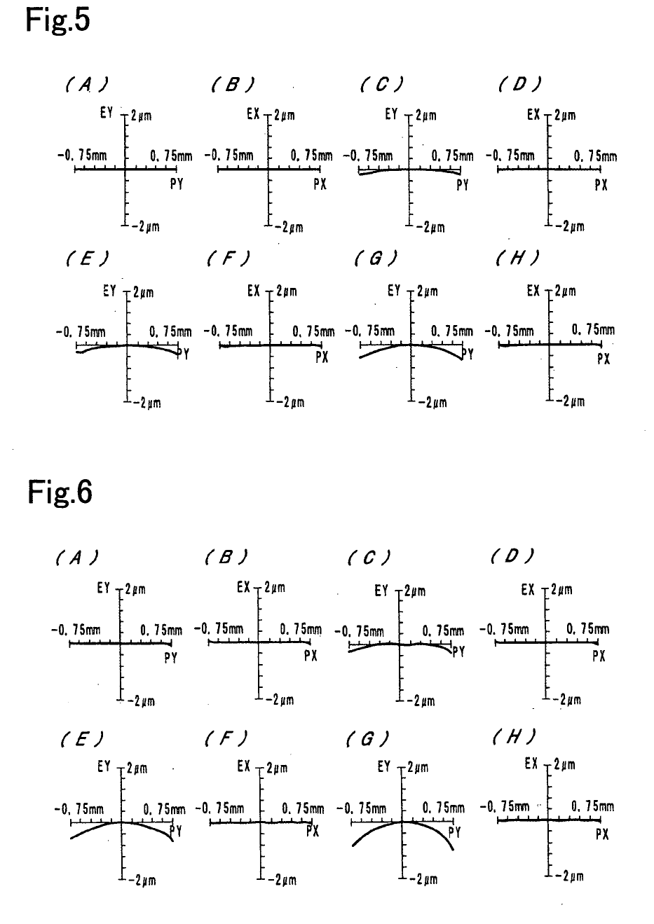

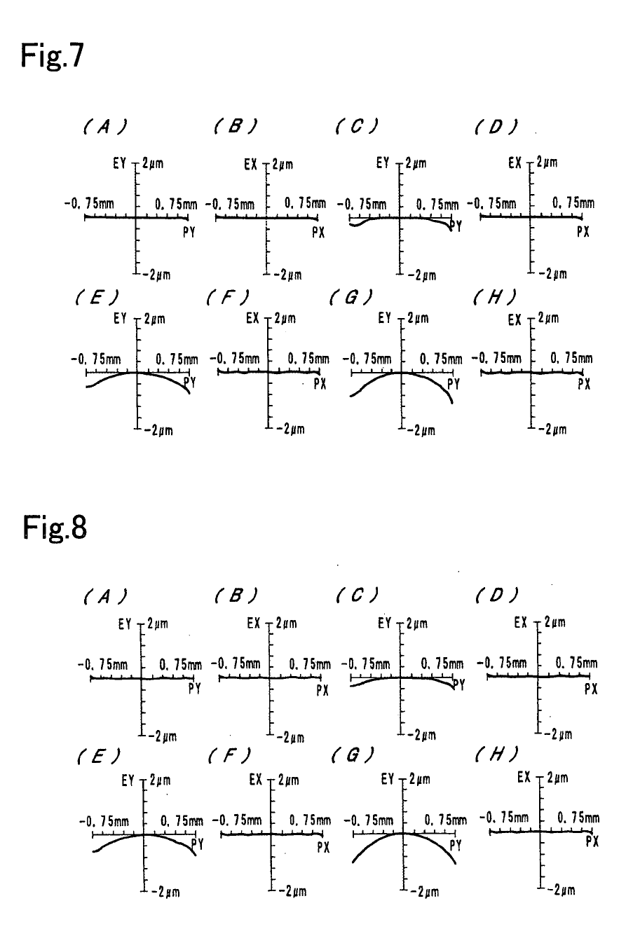

The aberration property in each of the above embodiments 1 to 4 is shown in FIG. 5 to FIG. 8. FIG. 5 corresponds to FIG. 1, FIG. 6 corresponds to embodiment 2, FIG. 7 corresponds to embodiment 3, and FIG. 8 corresponds to embodiment 4. In the graphs showing the respective aberration property, the axis of abscissa shows the relative pupil position. (A), (B) show the aberration with respect to the incident light of 0° on-axis, where (A) is the lateral aberration in the tangential direction and (B) is the lateral aberration in a sagittal direction. (C), (D) show the aberration with respect to the incident light of 0.1°, where (C) is the lateral aberration in the tangential direction and (D) is the lateral aberration in a sagittal direction. (E), (F) show the aberration with respect to the incident light of 0.2°, where (E) is the lateral aberration in the tangential direction and (F) is the lateral aberration in the sagittal direction. (G), (H) show the aberration with respect to the incident light of 0.3°, where (G) is the lateral aberration in the tangential direction and (H) is the lateral aberration in the sagittal direction.

In each of embodiments 1 to 4, as the first surface 12 is formed into an appropriate aspheric surface shape, the light condensing spot has small aberration and exhibits a satisfactory optical performance. Therefore, if the light condensing spot has small aberration with incident light of uniform lighting, light is condensed to a size of about 1.22×wavelength+NA (NA is numerical aperture).

The first surface 12 is a continuous aspheric surface and not a Fresnel surface nor a diffraction surface. In case of the Fresnel surface or the diffraction surface, discontinuous points form in the shape and thus the efficiency is lowered from scattering at the discontinuous point, which is not preferred. In case of a continuous surface as with the first surface 12, on the other hand, the light is efficiently transmitted, which is preferred.

The optical refractive power is also achieved with holography or gradient index lens. However, obtaining a satisfactory imaging performance or diffracting efficiency over a large NA is difficult. Therefore, refraction with continuous aspheric surface excels at condensing light at high NA. Preferably, the following conditional equation (2) is satisfied.
NA>0.6 (2)

The conditional equation (2) defines the numerical aperture (NA) of the optical system 10. NA=nsin θ, where n is the index of refraction of the light condensing point, and θ is the maximum axial angle of incidence. Since NA becomes small when exceeding the lower limit of the conditional equation (2), the light condensing spot becomes large and the light condensing efficiency of energy worsen, which is not preferable. Similarly, in case of when NA is less than or equal to the lower limit, the relatively efficient optical system is manufactured even when using the diffractive optical element or the gradient index lens. It is to be noted that NA of embodiments 1 to 4 is a value each noted in FIG. 1 to FIG. 4.

The second surface 13 is joined with the third surface 16 with an adhesive (suitably a transparent ultraviolet curing adhesive). As warp forms at the flat plate 15 from contraction when the adhesive is thick, the thickness of the adhesive is preferably made thin. Further, the variation of the thickness of the adhesive changes the position of the fourth surface 17 acting as a light condensing position, and thus if made as thin as possible, the positional change of the fourth surface also becomes small, which is preferable.

More specifically, the film thickness of the adhesive is preferably less than or equal to 50λ when the wavelength of the incident light is λ. This guarantees the variation of the fourth surface 17 to be less than or equal to a few wavelength when the change of film thickness is a few % of the total. More preferably, the film thickness of the adhesive is less than or equal to 10λ.

The light condensing spot is formed near the fourth surface 17 of the flat plate 15. A large NA is achieved with higher index of refraction at the vicinity of the light condensing spot, and as a result, a small spot is obtained. Therefore, the index of refraction of the flat plate 15 is preferably larger than the index of refraction of the aspherical lens 11 and the adhesive.

The sum of the thickness of the flat plate 15 and the thickness of the aspherical lens 11 determines the thickness of the entire optical system 10. In order to have the entire optical system 10 compact, the thickness of both components is preferably reduced. However, even if only the aspherical lens 11 or only the flat plate 15 is made thin, the refracting objective optical system with a satisfactory optical performance is difficult to obtain. More specifically, the following conditional equation (3) must be satisfied.
0.01<tP/tL<1.0 (3)
where
tL: thickness of aspherical lens
tP: thickness of transparent flat plate

The conditional equation (3) shows the ratio of the respective thickness of the aspherical lens 11 and the flat plate 15. When exceeding the upper limit of the conditional equation (3), the flat plate 15 becomes too large with respect to the aspherical lens 11. As a result, the diameter of the aspherical lens 11 cannot be made large, a large NA cannot be obtained, and thus the light condensing spot increases, which is not preferable. Preferably, the diameter of the lens (i.e., NA) is set large to obtain a satisfactory optical performance.

On the other hand, when exceeding the lower limit, the flat plate 15 becomes thin compared to the aspherical lens 11. Due to limitation in manufacturing, the lower limit of the thickness of the flat plate 15 substantially implies increase of aspherical lens 11. In this case, the optical system 10 becomes large as a whole, which is not preferable. If the upper limit of the conditional equation (3) is 0.5, the optical system 10 that is small and has satisfactory light condensing efficiency is obtained.

It is to be noted that tP/tL in embodiments 1 to 4 is a value each noted in FIG. 1 to FIG. 4.

The aspherical lens 11 has a very simple configuration made of a continuous aspheric surface (first surface 12) and a flat surface (second surface 13), and is formed using a conventional glass molding method or an injection molding method and is thus preferable. It is preferred that light weight is achieved if the aspherical lens 11 is manufactured with the injection molding method.

The incident ray is condensed near the fourth surface 17 of the flat plate 15. A light condensing spot of a size appropriate for the NA of the aspherical lens 11 is formed at the light condensing point. More specifically, if the incident ray is uniform, a pattern referred to as a so-called Airy disc is formed, which diameter D of the central spot thereof is generally known to be expressed with the following equation (4).
D=1.22λ/NA (4)

Therefore, if NA is 1.0 and the wavelength is 780 nm, the light condensing spot having a diameter D of 952 nm is obtained. However, the light condensing of wavelength order is the limit with the size of the spot determined by NA.

In order to obtain a smaller spot, a near field light generating structure having a dimension of less than or equal to the wavelength must be arranged in the vicinity of the light condensing spot. Preferably, such microscopic structure is a microscopic structure that generates a surface excitation plasmon, and particularly, that is manufactured from a metal that generates plasmon resonance.

Even with a structure having a dimension of less than or equal to the wavelength, the energy must be efficiently condensed at the microscopic spot, and a satisfactory light condensing efficiency is obtained through the use of a electric field amplification effect by the surface excitation plasmon resonance. It is, for example, known that gold or silver at 780 nm, aluminum or magnesium at 405 nm etc. has large electric field amplification effect.

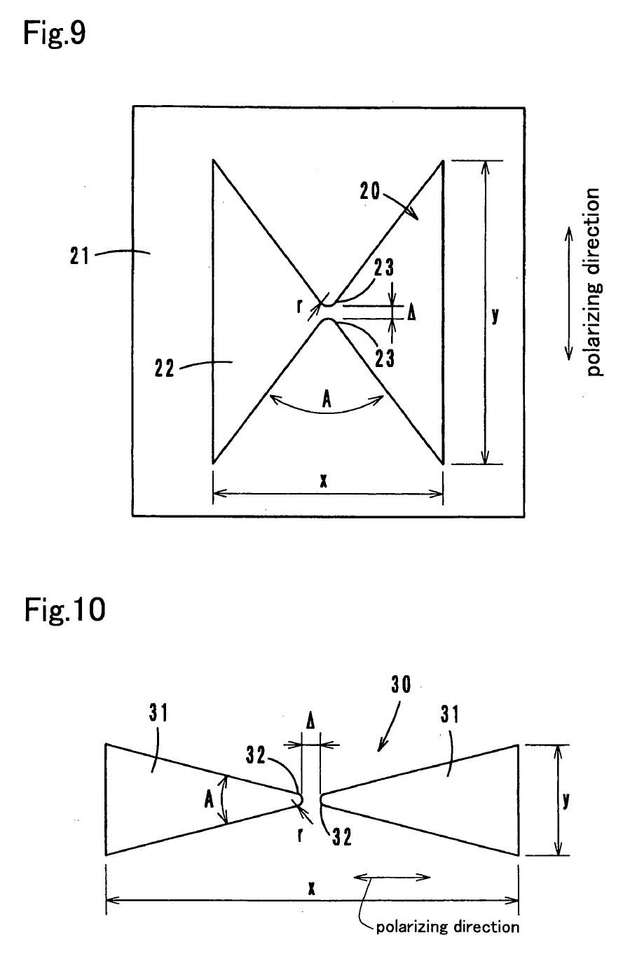

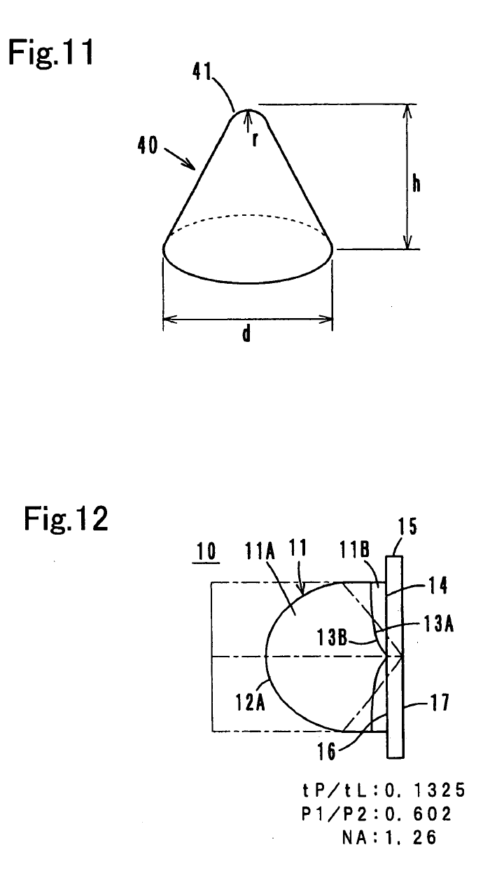

The plasmon resonance is effectively used by selecting the metal material and microscopic structure as well as thickness according to the wavelength, and the microscopic spot is efficiently obtained. The magnitude and the like of the electric field amplification effect are calculated using Finite Difference Time Domain (FDTD) Method. FIG. 9, FIG. 10, and FIG. 11 show specific examples of the microscopic structure 20, 30, and 40, where each microscopic structure 20, 30, 40 is formed by contacting the fourth surface 17 of the flat plate 15.

The microscopic structure 20 shown in FIG. 9 is such with a butterfly shape opening 22 formed in a thin film 21 made of the above metal having a thickness of 50 nm deposited on the fourth surface 17. With regards to specific shape examples 1 to 4, the longitudinal dimension y, the lateral dimension x, the open angle A, the distance (minimum structure dimension) Δ of the opposing projections 23, and the radius r of the opposing projections 23 are shown in table 5. In such microscopic structure 20, a strong electric field is generated at only near the minimum structure dimension Δ when the light condensing spot is illuminated.

TABLE 5

| | y (nm) | x (nm) | A (°) | Δ (nm) | r (nm) |
|---|---|---|---|---|---|
| Shape Example 1 | 1000 | 1000 | 90.0 | 50 | 20 |
| Shape Example 2 | 1000 | 800 | 77.3 | 30 | 20 |
| Shape Example 3 | 1000 | 600 | 61.9 | 20 | 50 |
| Shape Example 4 | 1000 | 400 | 43.6 | 20 | 20 |

The microscopic structure 30 shown in FIG. 10 is such with thin films 31 made of the above metal of a triangular shape having a thickness of 50 nm deposited on the fourth surface 17 formed so that the apexes thereof face each other. With regards to the specific shape examples 1 to 4, the longitudinal dimension y, the lateral dimension x, the open angle A, the distance (minimum structure dimension) Δ of the opposing projections 32, and the radius r of the opposing projections 32 are shown in table 6. In such microscopic structure 30, a strong electric field is generated at only near the minimum structure dimension Δ when the light condensing spot is illuminated.

TABLE 6

| | y (nm) | x (nm) | A (°) | Δ (nm) | r (nm) |
|---|---|---|---|---|---|
| Shape Example 1 | 400 | 1500 | 29.9 | 40 | 50 |
| Shape Example 2 | 600 | 1500 | 43.6 | 30 | 20 |
| Shape Example 3 | 800 | 1500 | 56.1 | 20 | 20 |
| Shape Example 4 | 1000 | 1500 | 67.4 | 20 | 30 |

The microscopic structure 40 shown in FIG. 11 is such formed into a substantially conical shape from the above metal on the fourth surface 17, where the distal end forms one part of a sphere. The substantially conical shape is entirely made of metal. With regards to the specific shape examples 1 to 4, the diameter d of the circular bottom surface contacting the fourth surface 17, the height h, and the radius r of the projection 41 are shown in table 7. In such microscopic structure 40, a strong electric field is generated at only near the projection 41 when the light condensing spot is illuminated.

TABLE 7

| | d (nm) | h (nm) | r (nm) |
|---|---|---|---|
| Shape Example 1 | 1000 | 1500 | 100 |
| Shape Example 2 | 1500 | 1000 | 50 |
| Shape Example 3 | 1000 | 1000 | 150 |
| Shape Example 4 | 1500 | 1500 | 100 |

The microscopic structures 20, 30, 40 are each applicable to any one of embodiments 1 to 4. With regards to the metal materials, aluminum and magnesium are preferable when using light of short wavelength of about 405 nm, and gold and silver are preferable when using light of long wavelength of about 780 nm for generating plasmon resonance of large electric field amplification.

The plasmon resonance is a phenomenon that depends on the incident polarization. In order to generate a strong resonance near the minimum structure dimension (between projections 23 and between projections 32) in the microscopic structures 20, 30, the polarizing direction of the incident light must be parallel to the direction in which the projections 23 and projections 32 face each other.

The microscopic structures 20, 30, 40 are arranged near the light condensing point of the fourth surface 17 of the flat plate 15 and there may only be one microscopic structure or a plurality of the same may be arranged in a matrix form. When arranging a plurality of microscopic structures as shown in FIG. 22, they are desirably arranged spaced apart by at least greater than or equal to the D value expressed in equation (3) in order not to simultaneously generate a plurality of microscopic spots. More desirably, they are spaced apart by a value twice or more of the D value to eliminate overlapping. The microscopic structures 20, 30, 40 are formed by directly fabricating metal using Focused Ion Beam (FIB) fabrication device or drawing resist using EB (electron beam) lithography and using micro-fabrication technique such as etching or lift off.

When light acts on the microscopic structure of less than or equal to the wavelength, the microscopic spot corresponding to the size of the structure is formed in the vicinity thereof. The microscopic light is referred to as the near field light and is a light localizing near the surface of the substance. The near field light is not propagation light and attenuates exponentially. Therefore, in performing recordation/reproduction, the recording/reproducing medium must be brought close to the microscopic structure (within three times the minimum structure dimension of the microscopic structure). More specifically, in microscopic structures 20, 30, the distance from the medium is preferably set to less than or equal to 60 nm when the minimum structure dimension Δ is 20 nm.

In the near field recordation/reproduction, the size of the near field light from the microscopic structure is known to be about that of the microscopic structure and the attenuating distance to be about the same extent. Therefore, to perform a more efficient recordation/reproduction, the medium is preferably brought close to less than or equal to the same extent as the minimum structure dimension.

In each embodiment 1 to 4, the aspherical lens 11 and the flat plate 15 are separately manufactured and then adhered together. Therefore, when forming the microscopic structure with a technique such as EB lithography, it is performed on a flat plate such as a wafer. It is manufactured through a simple step of cutting the wafer, on where the microscopic structure is formed, into a desired size to form the flat plate 15 and then joining the same with the aspherical lens 11.

Assuming the optical system is configured as an integrated object, the microscopic structure must be fabricated at the bottom surface of the material having the lens structure. The EB lithography process and the like includes a spin coating process etc. and thus easy handling of the fabricating sample influences the difficulty of fabrication. The material having the lens structure is difficult to handle compared to the wafer and thus increases fabrication difficulty and is not preferable. Further, in case of the wafer, by manufacturing in large quantity and then cutting into multiple flat plates 15, the productivity in one process is enhanced, but enhancement of productivity cannot be desired when including the lens structure.

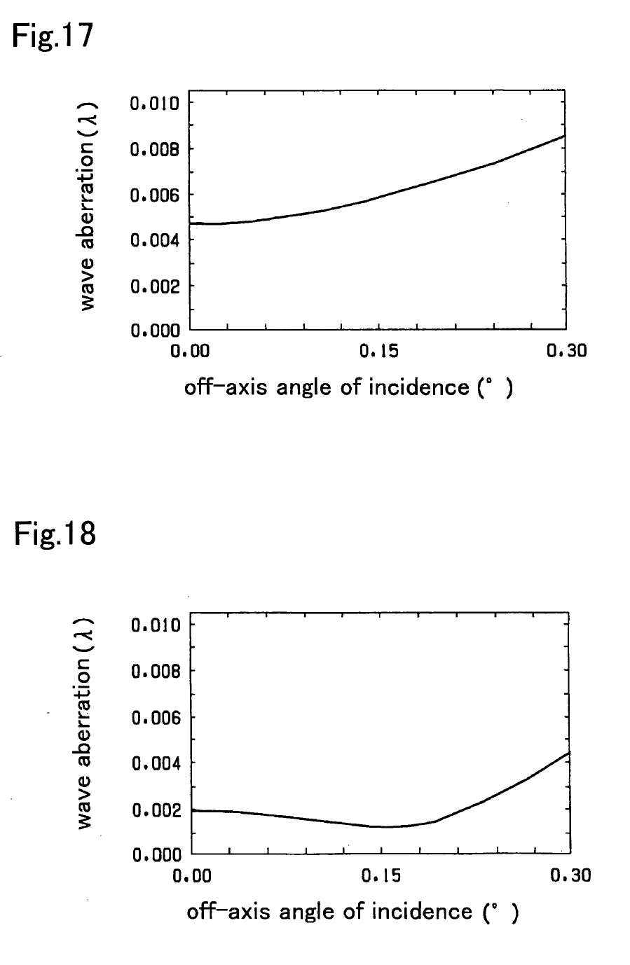

FIG. 12 to FIG. 16 show configurations and light paths (refer to a dashed line) of embodiments 5 to 9 of a refracting objective optical system according to the present invention. Further, FIG. 17 to FIG. 21 each shows off-axis aberration property of embodiments 5 to 9.

In each of FIG. 12 to FIG. 16, the refracting objective optical system 10 has the aspherical lens 11 configured with a compound lens of a first lens 11A and a second lens 11B, and other configurations, that is, arranging a transparent flat plate 15 including surfaces 16, 17 parallel to each other is the same as the above mentioned embodiments 1 to 4. Therefore, in embodiments 5 to 9 as well, other than the fact that the aspherical lens 11 is configured with a compound lens, the operational effects similar to embodiments 1 to 4 are obtained.

The cementing surfaces 13A, 13B of the first lens 11A and the second lens 11B are joined in the same shape. The plane of incidence 12A of the first lens 11A and the cementing surfaces 13A, 13B are each configured with an aspheric surface. Further, the exit surface 14 of the second lens 11B is a flat surface and is joined with the surface 16 of the flat plate 15 with an adhesive.

The lens 11 of embodiment 5 shown in FIG. 12 is a compound lens including a first lens 11A molded through glass molding method and a second lens 11B in which a transparent resin is molded on the first lens 11A. More specifically, an ultraviolet curing resin is arranged on the first lens 11A molded in advance, and the second lens 11B is molded with a metal mold and cured through irradiation of ultraviolet ray to manufacture.

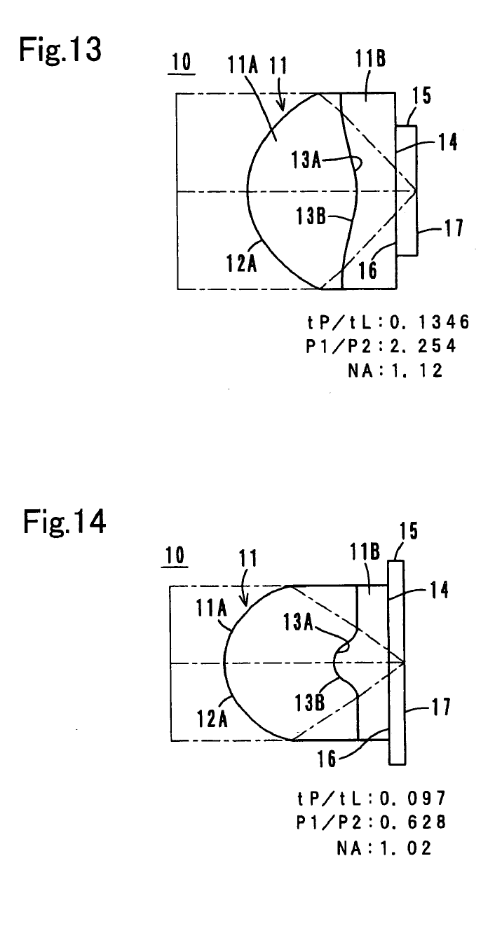

The lens 11 of embodiment 6 shown in FIG. 13 is a cemented lens in which the first and the second lens 11A, 11B molded through glass molding method are cemented with a transparent adhesive. The glass molding method is suitable for mass production and allows an aspherical lens of high precision to be manufactured at a relatively low price. The lens 11 of embodiment 7 shown in FIG. 14 is also a cemented lens manufactured similar to embodiment 6.

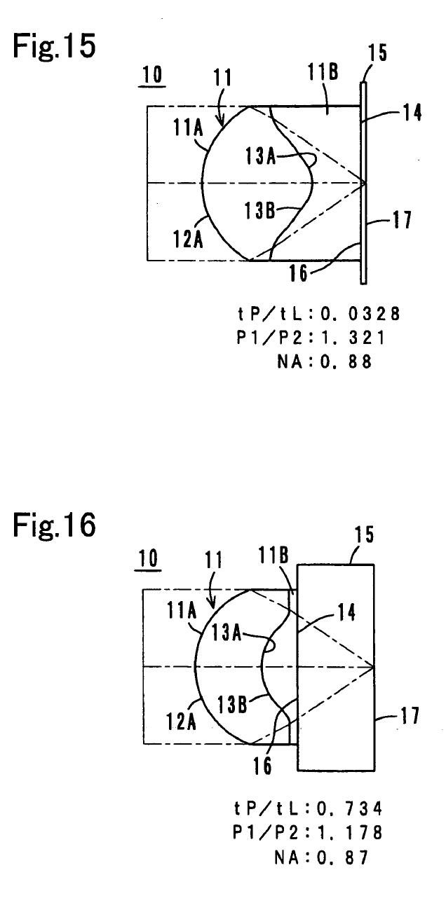

The lens 11 of embodiment 8 shown in FIG. 15 is a cemented lens in which the first lens 11A molded from polycarbonate and the second lens 11B molded from acryl are cemented with a transparent adhesive. The aspherical lens of high precision is manufactured in large quantity and inexpensively even with the injection molding method of resin. The resin lens is light in weight and is advantageous in mounting to a floating slider.

The lens 11 of embodiment 9 shown in FIG. 16 is a compound lens including the second lens 11B molded through glass molding method and the first lens 11A in which the transparent resin is molded on the second lens 11B. The manufacturing method thereof is similar to embodiment 5 but with the first lens and the second lens switched.

The construction data relating to embodiments 5 to 9 are shown in tables 8 to 12. The definitional equation of the aspheric surface is the same as the equation (1) mentioned above.

TABLE 8
Example 5

| | | |
|---|---|---|
| Wavelength | 780 | mm |
| Focal length in air | 0.583 | mm |
| Entrance pupil diameter | 1.5 | mm |
| Maximum axial angle of incidence | 60° | |

| | Aspheric | Curvature | | Index of |
|---|---|---|---|---|
| Surface number | surface | radius | Distance | refraction |
| First lens | Refer to | 0.6153995 | 1.112 | 1.79105 |
| | aspheric | | | |
| | surface 1 | | | |
| Second lens | Refer to | −0.131141 | 0.020 | 1.51118 |
| | aspheric | | | |
| | surface 2 | | | |
| Adhesive | | Infinity | 0.003 | 1.51118 |
| Flat plate | | Infinity | 0.150 | 1.45367 |
| (entrance surface) | | | | |
| Flat plate | | Infinity | | |
| (exit surface) | | | | |

| Aspheric | | | | |
|---|---|---|---|---|
| surface | K | A4 | A6 | A8 |
| 1 | −0.3688576 | 3.502E−02 | −6.456E−03 | −2.662E−01 |
| 2 | −6.950905 | 1.987E+00 | −4.754+00 | 6.121E+00 |

TABLE 9
Example 6

| | | |
|---|---|---|
| Wavelength | 405 | mm |
| Focal length in air | 0.664 | mm |
| Entrance pupil diameter | 1.5 | mm |
| Maximum axial angle of incidence | 50° | |

| | Aspheric | Curvature | | Index of |
|---|---|---|---|---|
| Surface number | surface | radius | Distance | refraction |
| First lens | Refer to | 0.6898008 | 0.811 | 1.86414 |
| | aspheric | | | |
| | surface 1 | | | |
| Adhesive | Refer to | −0.6007329 | 0.003 | 1.46958 |
| | aspheric | | | |
| | surface 2 | | | |
| Second lens | Refer to | −0.6007329 | 0.300 | 1.53020 |
| | aspheric | | | |
| | surface 3 | | | |
| Adhesive | | Infinity | 0.003 | 1.53020 |
| Flat plate | | Infinity | 0.150 | 1.46958 |
| (entrance surface) | | | | |
| Flat plate | | Infinity | | |
| (exit surface) | | | | |

| Aspheric | | | | |
|---|---|---|---|---|
| surface | K | A4 | A6 | A8 |
| 1 | −0.3933128 | 2.562E−02 | −4.727E−02 | −1.020E−02 |
| 2 | −12.31497 | 2.940E−01 | −3.149E−01 | 1.737E−01 |
| 3 | −12.31497 | 2.940E−01 | −3.149E−01 | 1.737E−01 |

TABLE 10
Example 7

| | | |
|---|---|---|
| Wavelength | 780 | mm |
| Focal length in air | 0.751 | mm |
| Entrance pupil diameter | 1.5 | mm |
| Maximum axial angle of incidence | 35° | |

| | Aspheric | Curvature | | Index of |
|---|---|---|---|---|
| Surface number | surface | radius | Distance | refraction |
| First lens | Refer to | 0.679437 | 1.029 | 1.51118 |
| | aspheric | | | |
| | surface 1 | | | |
| Adhesive | Refer to | 0.2334879 | 0.010 | 1.45367 |
| | aspheric | | | |
| | surface 2 | | | |
| Second lens | Refer to | 0.2334879 | 0.500 | 1.79105 |
| | aspheric | | | |
| | surface 3 | | | |
| Adhesive | | Infinity | 0.003 | 1.45367 |
| Flat plate | | Infinity | 0.150 | 1.78566 |
| (entrance surface) | | | | |
| Flat plate | | Infinity | | |
| (exit surface) | | | | |

| Aspheric | | | | |
|---|---|---|---|---|
| surface | K | A4 | A6 | A8 |
| 1 | −0.242945 | −1.360E−01 | 4.776E−01 | −4.655E−01 |
| 2 | −1.063762 | 7.280E+00 | 1.013E+02 | −1.591E+03 |
| 3 | −1.063762 | 7.280E+00 | 1.013E+02 | −1.591E+03 |

TABLE 11
Example 8

| | | |
|---|---|---|
| Wavelength | 405 | mm |
| Focal length in air | 0.842 | mm |
| Entrance pupil diameter | 1.5 | mm |
| Maximum axial angle of incidence | 37° | |

| | Aspheric | Curvature | | Index of |
|---|---|---|---|---|
| Surface number | surface | radius | Distance | refraction |
| First lens | Refer to | 0.687008 | 1.057 | 1.62231 |
| | aspheric | | | |
| | surface 1 | | | |
| Adhesive | Refer to | −0.1689282 | 0.003 | 1.46958 |
| | aspheric | | | |
| | surface 2 | | | |
| Second lens | Refer to | −0.1689282 | 0.463 | 1.50650 |
| | aspheric | | | |
| | surface 3 | | | |
| Adhesive | | Infinity | 0.003 | 1.53020 |
| Flat plate | | Infinity | 0.050 | 1.46958 |
| (entrance surface) | | | | |
| Flat plate | | Infinity | | |
| (exit surface) | | | | |

| Aspheric | | | | |
|---|---|---|---|---|
| surface | K | A4 | A6 | A8 |
| 1 | −0.4249526 | 1.050E−02 | −9.295E−02 | −7.485E−02 |
| 2 | −2.508024 | 3.287E−01 | −3.422E−01 | 1.942E−01 |
| 3 | −2.508024 | 3.287E−01 | −3.422E−01 | 1.942E−01 |

TABLE 12
Example 9

| | | |
|---|---|---|
| Wavelength | 532 | mm |
| Focal length in air | 0.898 | mm |
| Entrance pupil diameter | 1.5 | mm |
| Maximum axial angle of incidence | 35° | |

| | Aspheric | Curvature | | Index of |
|---|---|---|---|---|
| Surface number | surface | radius | Distance | refraction |
| First lens | Refer to | 0.7520573 | 0.615 | 1.51947 |
| | aspheric | | | |
| | surface 1 | | | |
| Second lens | Refer to | 0.5 | 0.338 | 1.81263 |
| | aspheric | | | |
| | surface 2 | | | |
| Adhesive | | Infinity | 0.001 | 1.46071 |
| Flat plate | | Infinity | 0.700 | 1.51947 |
| (entrance surface) | | | | |
| Flat plate | | Infinity | | |
| (exit surface) | | | | |

| Aspheric | | | | |
|---|---|---|---|---|
| surface | K | A4 | A6 | A8 |
| 1 | −0.07389159 | −2.815E−01 | 6.455E−01 | −6.865E−01 |
| 2 | −0.2731615 | 9.787E−01 | −5.448+00 | −1.701E+01 |

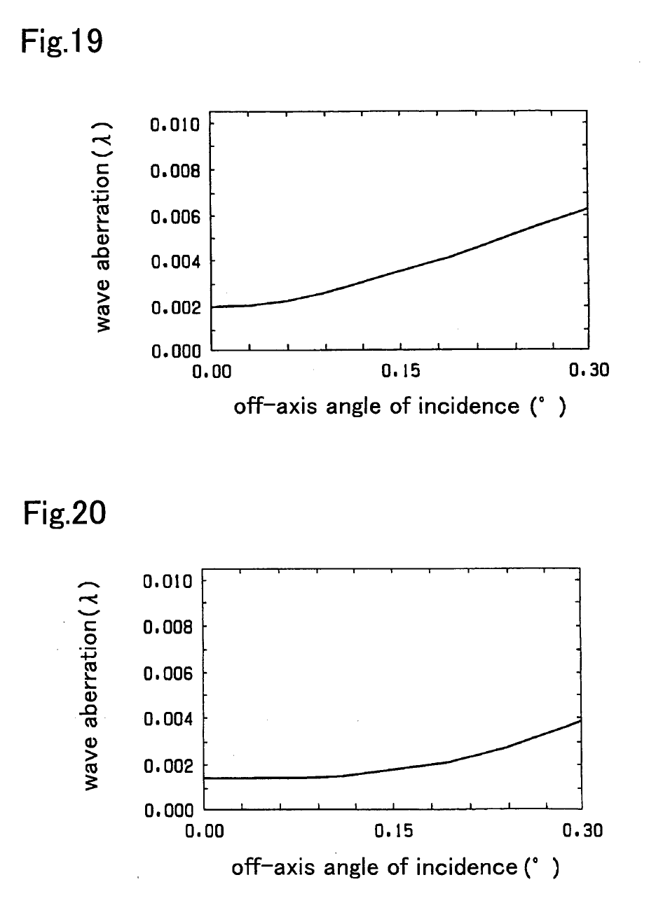

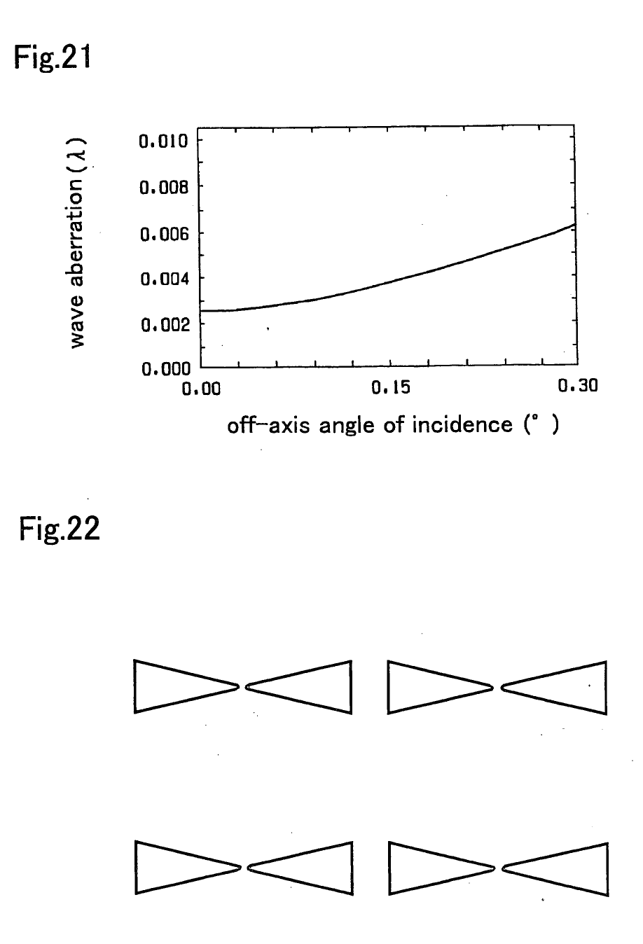

FIG. 1-7 to FIG. 21 each shows the off-axis aberration property of embodiments 5 to 9. FIG. 17 corresponds to embodiment 5, FIG. 18 corresponds to embodiment 6, FIG. 19 corresponds to embodiment 7, FIG. 20 corresponds to embodiment 8 and FIG. 21 corresponds to embodiment 9. In the graphs showing each off-axis aberration property, the axis of abscissa shows the off-axis angle of incidence and the axis of ordinate shows the RMS value (root mean square) of the wave aberration in units of wavelength λ. It is to be noted that the axial aberration property may be corrected similar to that explained with embodiments 1 to 4.

In embodiments 5 to 9, since each of the refractive objective optical systems is configured with two aspheric surfaces of the plane of incidence 12A of the first lens 11A and the cementing surface 13A, the on-axis aberration and the off-axis aberration are satisfactorily corrected by setting the aspheric surface coefficient thereof to be optimum. For example, in embodiment 5 shown in FIG. 17, the wave aberration RMS value is corrected to less than or equal to 0.01λ even with an angle of incidence of 0.30°.

In embodiment 5 shown in FIG. 12, the cementing surfaces of the lenses 11A, 11B have a convex surface shape on the exit side. As the index of refraction of the first lens 11A is greater than that of the second lens 11B, the convex surface shape thereof has a positive refractive power. In terms of degree of freedom of design of the two optical surfaces, the positive index of refraction is preferably distributed at the cementing surface for light condensing.

In embodiment 7 shown in FIG. 14, the index of refraction of the second lens 11B is greater than that of the first lens 11A, and thus the cementing surface has a convex surface shape on the entrance side. The convex surface shape also has a positive optical power and is a preferable configuration in terms of aberration correction.

In embodiments 5 to 9, assuming the power of the plane of incidence 12A of the first lens 11A is P1 and the power of the cementing surface 13A with the second lens 11B is P2, the following equation (5) is preferably satisfied to secure satisfactory aberration correction.
0.1<P1/P2<5 (5)
where
P1=(N1−1)/CR1
P2=(N2−N1)/CR2
N1: index of refraction of the first lens
N2: index of refraction of the second lens
CR1: curvature radius of plane of incidence of the first lens
CR2: curvature radius of cementing surface of the first lens

When P1/P2 exceeds 5, the power distribution at power P1 becomes too large and the advantage of configuring with a cemented lens or a compound lens is not exhibited, that is, correction of off-axis aberration becomes difficult. When P1/P2 is below 0.1, the power of the cementing surface becomes too large. That is, the curvature radius of the cementing surface becomes too small with respect to the plane of incidence of the first lens 11A, and as a result, the lens becomes difficult to manufacture. The range of 0.3<P1/P2<3 is suitable.

The values of P1/P2 in embodiments 5 to 9 are each noted in FIG. 12 to FIG. 16. Each of the values of tP/tL and NA is also noted.

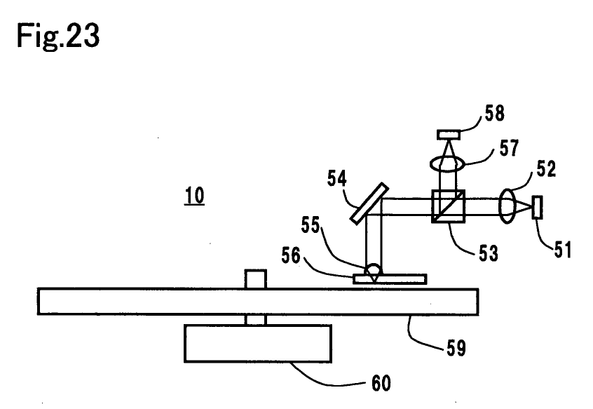

FIG. 23 shows an optical recording/reproducing device equipped with the refracting objective optical system of the present invention. The laser beam exiting from a semiconductor laser 51 is collimated by a collimator lens 52 and transmits a beam splitter 53 and is bent at right angles at the reflection mirror 54 and enters a refracting objective optical system 10 including an aspherical lens 55 and a transparent flat plate 56. The near field light generated at the exit surface of the transparent flat plate 56 is brought close so as to reach a information recording medium 59 supported by a rotating means 60 to record or reproduce information with the near field light. The reflected light from the recording medium 59 is collected by the refracting objective optical system 10 and is bent by the reflection mirror 54 and is reflected by the beam splitter 53 and is converged by a detection lens 57 on a light detector 58.

The original aim of configuring the aspherical lens 11 as the cemented lens or the compound lens is for off-axis aberration correction, but further facilitates removing the influence by wavelength variation of the light source by setting a suitable Abbe constant. More specifically, achromatic configuration is desired. When the focal length is a positive lens and a negative lens in a single unit of the first lens 11A and the second lens 11B, color correction is performed by having the Abbe constant of the negative lens smaller than the Abbe constant of the positive lens.

The refracting objective optical system 10 of embodiments 1 to 9 is mounted to the air floating slider of an optical recording/reading device. In this case, the ABS (Air Bearing Surface) structure is suitably formed on the surface 17 of the flat plate 15. The ABS structure is generally fabricated by means of the lithography technique. By fabricating the ABS structure at the exit surface 17 of the flat plate 15 of mother board state with lithography and cutting the above into individual flat plates 15 with a dicer and the like and subsequently joining the same with the lens 11, mass production becomes possible. Fabricating the ABS structure on the lens 11 itself is extremely difficult and attaching a suspension for floating is also difficult.

Further, each embodiment 1 to 9 show the construction optimized for the parallel light (infinity). This is to respond, when the optical system 10 is mounted to the floating slider, to change in floating height of the slider (optical system 10) from undulation of the recording medium surface when the recording medium rotates and the slider follows and floats. In this case, if the incident ray is infinite, the position of the light condensing spot is always in the vicinity of the exit surface irrespective of the floating height of the optical system 10. In case of finite conjugation, on the other hand, the follow variation of the slider becomes the variation of the object distance, and thus the position of the light condensing spot varies, which is not preferable. However, the optical system 10 may be used without trouble at a state of finite conjugation as long as it is within a range that barely influences the position of the light condensing spot even if the incident ray is shifted from infinity.

The refracting objective optical system and the optical recording/reproducing device according to the present invention are not limited to the above embodiments, and may of course be modified into various forms within the scope of the invention. Particularly, the details of the configuration of the aspherical lens and the transparent flat plate are optional and the above mentioned construction data thereof are merely an example.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A refracting objective optical system comprising:
an aspherical lens in which an entrance surface is a continuous aspheric surface of convex shape and an exit surface is a flat surface; and
a transparent flat plate joined to the flat surface of the aspherical lens, where the ray entering the aspheric surface of the aspherical lens is refracted at the aspheric surface, transmitted through the flat surface or the joint surface, and condensed near the exit surface of the transparent flat plate,
wherein the transparent flat plate includes a microscopic structure for generating a near field light smaller than a light condensing spot near the light condensing point of the exit surface and satisfies the following condition
0.01<tP/tL<1.0,
where the thickness of the transparent flat plate is tP and the thickness of aspherical lens is tL.

2. A refracting objective optical system of claim 1, wherein the numerical aperture NA of the aspherical lens is greater than 0.6.

3. A refracting objective optical system of claim 1, wherein the microscopic structure is formed by a metal that generates plasmon resonance.

4. A refracting objective optical system of claim 3, wherein the metal is either aluminum or magnesium.

5. A refracting objective optical system of claim 1, wherein the microscopic structure has a configuration in which the distal ends of one pair of projections face each other and are brought close to each other, and a light of a polarizing direction substantially parallel to the direction the pair of distal ends face each other enters therein.

6. A refracting objective optical system of claim 5, wherein the number of pair of projections is more than one.

7. A refracting objective optical system of claim 1, wherein the film thickness of the adhesive interposed between the aspherical lens and the transparent flat plate is less than or equal to 50λ where λ is the wavelength of the incident light.

8. A refracting objective optical system of claim 1, wherein the numerical aperture NA of the aspherical lens of the refracting objective optical system is greater than 0.8 and the absolute value of curvature radius of the aspherical lens is smaller than 1 mm.

9. A refracting objective optical system of claim 1, wherein the aspherical lens is configured from a first lens made of a first material having a predetermined index of refraction, and a second lens made of a second material having a predetermined index of refraction, where the opposing surfaces of the first and the second lenses have substantially same shapes and adhere, and the incident ray is transmitted in the order of the first lens, the second lens and the transparent flat plate and condensed near the exit surface of the transparent flat plate.

10. A refracting objective optical system of claim 9, wherein a power of an incidence plane of the first lens is P1 and a power of a surface cementing with the second lens is P2, the following condition is satisfied.
0.1<P1/P2<5
where
P1=(N1−1)/CR1
P2=(N2−N1)/CR2
N1: index of refraction of the first lens
N2: index of refraction of the second lens
CR1: curvature radius of incidence plane of the first lens
CR2: curvature radius of cementing surface of the first lens

11. A refracting objective optical system of claim 9, wherein the cementing surfaces of the first lens and the second lens are aspheric surfaces.

12. A refracting objective optical system of claim 9, wherein the first lens and the second lens are molded through the glass molding method or the injection molding method and then adhered by way of an adhesive layer.

13. A refracting objective optical system of claim 9, wherein the first lens and the second lens are adhered to be a compound lens in which one of the first lens or the second lens is molded through the glass molding method or the injection molding method and the other lens is integrated thereto by molding the transparent resin on the relevant lens.

14. A refracting objective optical system of claim 9, wherein the thickness of first lens is more twice than the thickness of the second lens.

15. An optical recording/reproducing device comprising:
an objective optical system including an aspherical lens of which an entrance surface is a continuous aspheric surface of convex shape and an exit surface is a flat surface, and a transparent flat plate joined to the flat surface of the aspherical lens; and
a recording medium,
wherein the transparent flat plate includes a microscopic structure for generating a near field light smaller than a light condensing spot near the light condensing point of the exit surface, the distance between the objective optical system and the recording medium is within the three times of the minimum structure dimension of the microscopic structure.
